(19) United States
(12) Patent Application Publication
(10) Pub. No.: US 2017/0026836 A1
(43) Pub. Date: Jan. 26, 2017

(54) ATTRIBUTE-BASED CONTINUOUS USER AUTHENTICATION ON MOBILE DEVICES

(71) Applicant: UNIVERSITY OF MARYLAND, COLLEGE PARK, College Park, MD (US)

(72) Inventors: Pouya SAMANGOUEI, Adelphi, MD (US); Vishal M. PATEL, Silver Spring, MD (US); Ramalingam CHELLAPPA, Potomac, MD (US); Emily HAND, Reno, NV (US)

(21) Appl. No.: 15/215,576

(22) Filed: Jul. 20, 2016

Related U.S. Application Data
(60) Provisional application No. 62/194,603, filed on Jul. 20, 2015.

(51) Int. Cl. H04W 12/06; G06K 9/00; H04L 29/06

(52) U.S. Cl. CPC H04W 12/06; H04L 63/0861; G06K 9/00288

(57) ABSTRACT

Various devices and systems may benefit from convenient authentication. For example, certain mobile devices may benefit from attribute-based continuous user authentication. A method can include determining attributes of an authorized user of a mobile device. The method can also include obtaining an unconstrained image of a current user of the mobile device. The method can further include processing the unconstrained image to determine at least one characteristic of the current user. The method can additionally include making an authorization determination based on a comparison between the attributes and the determined characteristic.

### CROSS-REFERENCE TO RELATED APPLICATION

This application is a non-provisional of, and claims the benefit and priority of, U.S. Provisional Patent Application No. 62/194,603 filed Jul. 20, 2015, “Attribute-based Continuous User Authentication on Mobile Devices,” the entirety of which is hereby incorporated herein by reference.

### GOVERNMENT LICENSE RIGHTS

This invention was made with government support under FA87501320279 awarded by AFRL. The government has certain rights in the invention.

### BACKGROUND

Field

Various devices and systems may benefit from convenient authentication. For example, certain mobile devices may benefit from attribute-based continuous user authentication.

Description of the Related Art

Advances in communication and sensing technologies have led to an exponential growth in the use of mobile devices such as smartphones and tablets. Mobile devices are becoming increasingly popular due to their flexibility and convenience in managing personal information. Indeed, mobile devices, such as cellphones, tablets, and smart watches have become inseparable parts of people's lives.

Traditional methods for authenticating users on mobile devices are based on passwords, pin numbers, secret patterns or fingerprints. As long as the mobile phone remains active, typical devices incorporate no mechanisms to verify that the user originally authenticated is still the user in control of the mobile device. Thus, unauthorized individuals may improperly obtain access to personal information of the user if a password is compromised or if a user does not exercise adequate vigilance after initial authentication on a device.

The users often store important information such as bank account details or credentials to access their sensitive accounts on their mobile phones. Moreover, nearly half of the users do not use any form of authentication mechanism for their phones because of the frustrations made by these methods. Even if they do, as mentioned above, the initial password-based authentication can be compromised and thus it cannot continuously protect the personal information of the users.

### SUMMARY

According to certain embodiments, a method can include determining attributes of an authorized user of a mobile device. The method can also include obtaining an unconstrained image of a current user of the mobile device. The method can further include processing the unconstrained image to determine at least one characteristic of the current user. The method can additionally include making an authorization determination based on a comparison between the attributes and the determined characteristic.

In certain embodiments, an apparatus can include at least one processor and at least one memory including computer program code. The at least one memory and the computer program code can be configured to, with the at least one processor, cause the apparatus at least to determine attributes of an authorized user of a mobile device. The at least one memory and the computer program code can also be configured to, with the at least one processor, cause the apparatus at least to obtain an unconstrained image of a current user of the mobile device. The at least one memory and the computer program code can further be configured to, with the at least one processor, cause the apparatus at least to process the unconstrained image to determine at least one characteristic of the current user. The at least one memory and the computer program code can additionally be configured to, with the at least one processor, cause the apparatus at least to make an authorization determination based on a comparison between the attributes and the determined characteristic.

An apparatus, according to certain embodiments, can include means for determining attributes of an authorized user of a mobile device. The apparatus can also include means for obtaining an unconstrained image of a current user of the mobile device. The apparatus can further include means for processing the unconstrained image to determine at least one characteristic of the current user. The apparatus can additionally include means for making an authorization determination based on a comparison between the attributes and the determined characteristic.

A non-transitory computer readable medium can be encoded with instructions that, when executed in hardware, perform a process. The process can include determining attributes of an authorized user of a mobile device. The process can also include obtaining an unconstrained image of a current user of the mobile device. The process can further include processing the unconstrained image to determine at least one characteristic of the current user. The process can additionally include making an authorization determination based on a comparison between the attributes and the determined characteristic.

A computer program product can encode instructions for performing a process. The process can include determining attributes of an authorized user of a mobile device. The process can also include obtaining an unconstrained image of a current user of the mobile device. The process can further include processing the unconstrained image to determine at least one characteristic of the current user. The process can additionally include making an authorization determination based on a comparison between the attributes and the determined characteristic.

### BRIEF DESCRIPTION OF THE DRAWINGS

For proper understanding of the invention, reference should be made to the accompanying drawings, wherein:

FIG. 1 illustrates a training phase pipeline for each attribute classifier, according to certain embodiments.

FIG. 2 illustrates a method according to certain embodiments.

FIG. 3 illustrates two possible architectures for networks according to certain embodiments of the present invention.

FIG. 4 illustrates a multi-task convolutional neural network according to certain embodiments.

FIG. 5 shows the connection between MCNN and AUX, according to certain embodiments.

FIG. 6 illustrates a method according to certain embodiments.

FIG. 7 illustrates a system according to certain embodiments.

### DETAILED DESCRIPTION

Certain embodiments provide a method of using facial attributes for continuous authentication of smartphone users. The binary attribute classifiers can be trained using, for example, a PubFig dataset, and can provide compact visual descriptions of faces. The learned classifiers can be applied to the image of the current user of a mobile device to extract the attributes. Authentication can be done by comparing the difference between the acquired attributes and the enrolled attributes of the original user. Certain embodiments applied to unconstrained mobile face video datasets can capture meaningful attributes of faces and perform better than previously proposed local binary pattern (LBP)-based authentication methods.

For example, a deep convolutional neural network (DCNN) architecture can be provided for the task of continuous authentication on mobile devices. To deal with the limited resources of these devices or for other reasons such as speed, the complexity of the networks can be reduced by learning intermediate features such as gender and hair color instead of identities.

A multi-task, part-based DCNN architecture can be used for attribute detection and can perform better than the conventional methods, in terms of accuracy.

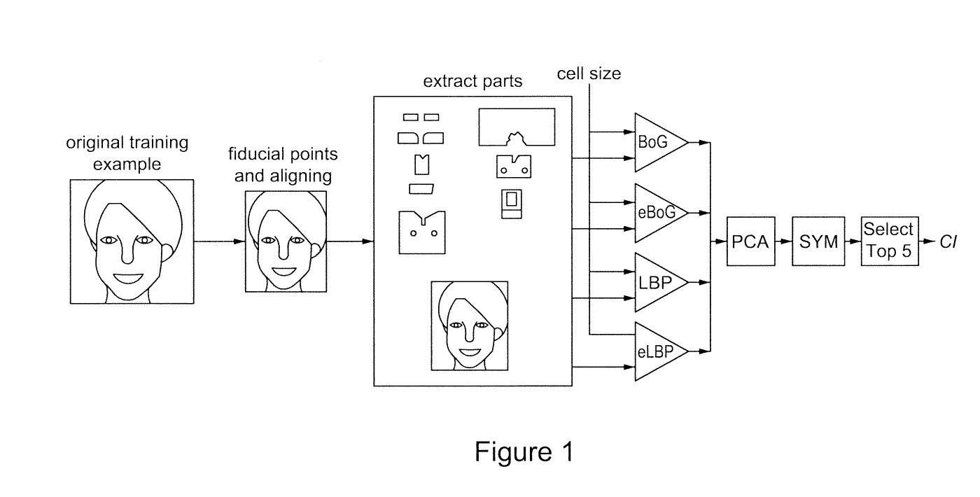

FIG. 1 illustrates a training phase pipeline for each attribute classifier, according to certain embodiments. Landmarks can be first detected on a given face. Different facial components can then be extracted from these landmarks. Then for each part, features can be extracted with different cell sizes and the dimensionality of features can be reduced using the PCA. Classifiers can then be learned on these low-dimensional features. Finally, top five Cis can be selected as attribute classifiers.

Each attribute classifier Clᵢε{Cl₁, . . . Cl_{N}} can be trained by an automatic procedure of model selection for each attribute AᵢEε{A₁, . . . , A_{N}}, where N is the total number of attributes. Automatic selection can be used as each attribute may need a different model. Models can be indexed in various ways.

For each attribute, a set of different facial parts or components can be more discriminative. The face components considered for training can include eyes, nose, mouth, hair, eyes&nose, mouth&nose, eyes&nose&mouth, eyes&eyebrows, and the full face. In total, nine different face components can be considered in certain embodiments.

For different attributes, different types of features may be needed. For example, for the attribute “blond hair,” features related to color can be more discriminative than features related to texture. In certain embodiments, four types of features may be used, including local binary patterns (LBP), color LBP, histogram of oriented gradients (HOG), and color HOG.

In order to capture local information regarding the locality of the features, different cell sizes of the HOG and the LBP features can be considered. In total, six different cell sizes, 6, 8, 12, 16, 24, 32, can be used in certain embodiments.

Any available fiducial point detection method can be used to extract the different facial components. Furthermore, the detected landmarks can also be used to align the faces to a canonical coordinate system. After extracting each set of features, the principal component analysis (PCA) can be used with 99% of the energy to project each feature onto a low-dimensional subspace. A support vector machine (SVM) with the RBF kernel can then be learned on these features. This process can be run exhaustively to train all possible models. For each attribute classifier, most of the available data can be used for training the SVMs and the remaining data can be used for model selection. The face images in the test set do not need to overlap with those in the training set. Total number of negative and positive classes can be the same for both training and testing Finally, among all 216 SVMs, five with the best accuracies can be selected.

Continuous authentication can be treated as an attempt at verification regarding whether a given pair of videos or images correspond to the same person or not. The receiver operating characteristic (ROC) curve, which describes the relations between false acceptance rates (FARs) and true acceptance rates (TARs), can be used to evaluate the performance of verification algorithms. As the TAR increases, so does the FAR.

Therefore, one would expect an ideal verification framework to have TARs all equal to 1 for any FARs, The ROC curves can be computed given a similarity matrix.

Certain embodiments can extract an attribute vector from each image in a given video. The vectors can then be averaged to obtain a single attribute vector that represents the entire video.

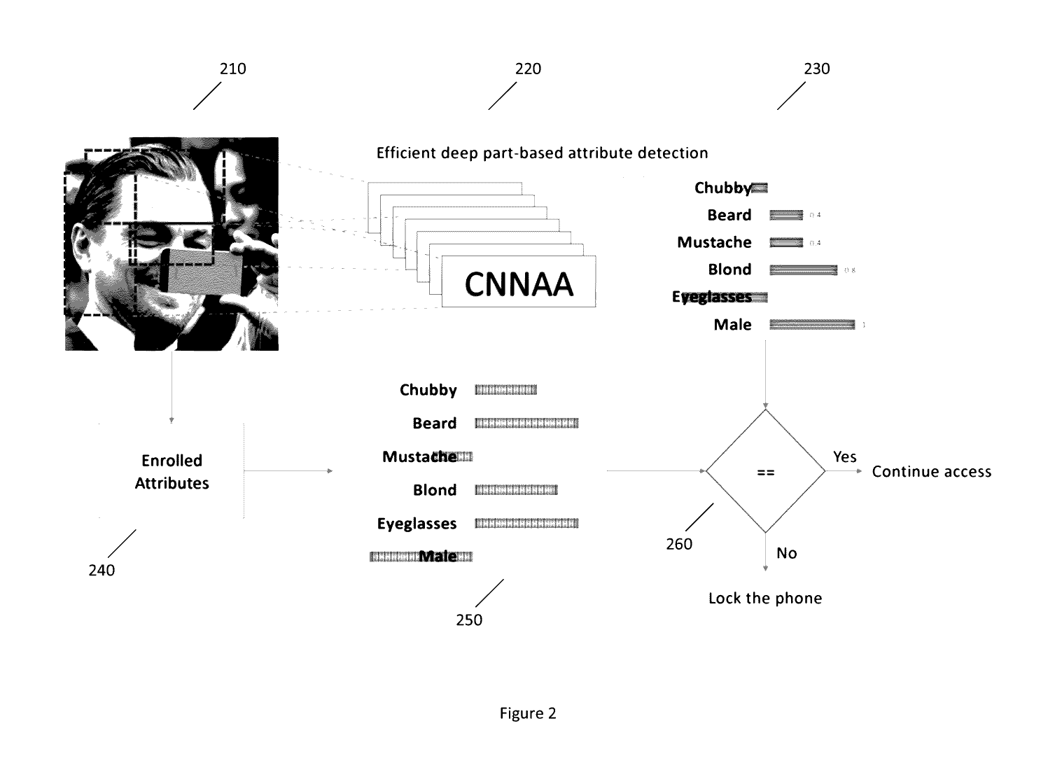

FIG. 2 illustrates a method according to certain embodiments. To authenticate the users, facial attributes can be extracted. These attributes can be extracted by extracting the face parts and feeding them to a convolutional neural network (CNN) for facial attribute-based active authentication (CNNAA), which can be an ensemble of efficient multi-task deep CNNs (DCNNs).

As shown in FIG. 2, the method can involve capturing images of a user of the device at 210. In the case of an enrollment procedure, the attributes of these images can provided as enrolled attributes at 240. Alternatively, the enrolled attributes can be entered by a self-description from the user. If images are used in the enrollment process, these may be input at various times, such as whenever a correct authentication code is provided or the first time a mobile device is used after a predetermined period of non-use. The image may be captured automatically without user input using a built-in camera of the mobile device. Other enrollment techniques are also permitted.

The enrolled attributes can be a specific set, such as chubby, beard, mustache, blond, eyeglasses, and male, as shown at 250. This may be a subset of all possible attributes, such as attributes that are particularly easy to detect or otherwise good discriminators between the authenticated user and other users.

During use, the images taken at 210 can be provided to an efficient deep part-based attribute detection network. These can extract a set of attributes at 230, which can be the same set or a different set from the enrolled set of attributes.

At 260, a comparison between enrolled and more recently extracted attributes can be performed. If the attributes match, access can be continued. Otherwise, the phone or other mobile device can be locked. The match does not have to be a precise match. For example, as shown in FIG. 2 the “chubby” value may be harder to evaluate depending on the pose or orientation of the user. Accordingly, a large degree of mismatch regarding this attribute may be permitted. On the other hand, an indicator like beard, eyeglasses, or gender may be subject to a tighter limitation, as these may not be expected to change significantly, regardless of pose or orientation.

An individual or collective threshold can be applied to the attributes. Authentication, therefore, can depend on the threshold or thresholds being met to a predetermined degree. In the particular example of FIG. 2, because eyeglasses, and gender seem to be clearly different, the option of locking the device may be taken. The locking can also be accompanied by other security actions, such as logging and/or reporting.

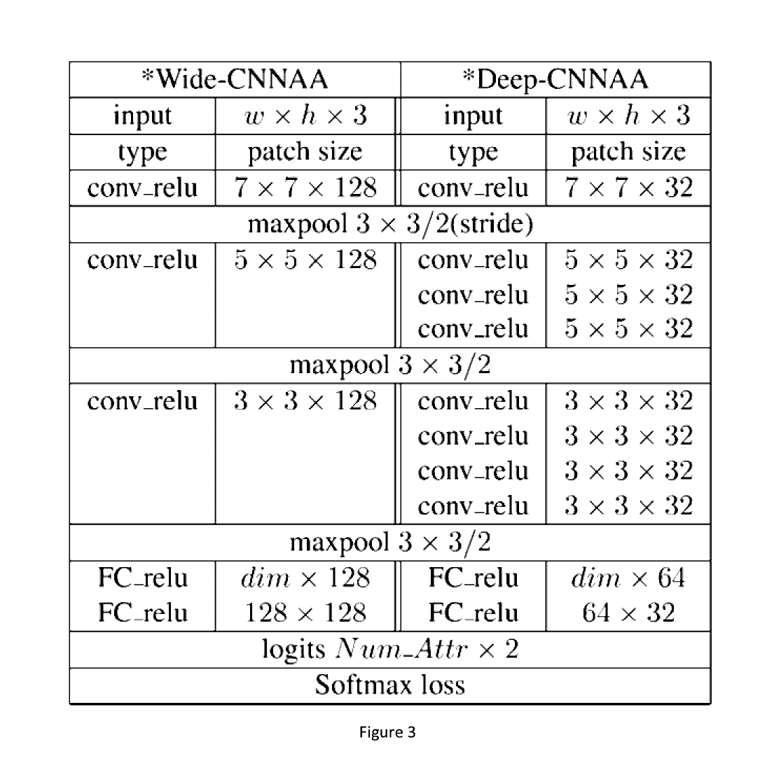

FIG. 3 illustrates two possible architectures for networks according to certain embodiments of the present invention. As shown in FIG. 3, the two architectures can include a Deep Convolutional Neural Network for facial Attribute-based Active authentication (Deep-CNNAA) and Wide-CNNAA.

Four sets of models based on these two architectures can include BinaryDeep-CNNAA and BinaryWide-CNNAA, which are single task networks, as well as MultiDeep-CNNAA and MultiWide-CNNAA, which are multi-task networks. While these are example networks and models that can be used, other networks and models are permitted.

Care can be taken when training these networks to ensure that classes with more available training data do not unduly influence the results. Thus, the training of the networks can be manipulated by adding in distorted versions of rarer cases, so that the number of images from each class is approximately equal.

Attributes, or semantic features, can be used in a variety of ways, including activity recognition in video and face verification. Improving the accuracy of attribute classifiers can be an important first step in any application which uses these attributes. Attributes are typically considered to be independent in conventional usage of attributes.

However, many attributes are very strongly positively related, such as heavy makeup and wearing lipstick or very strongly negatively related such as being female and having a full beard. Attribute relationships can be exploited in, for example, three ways: by using a multi-task deep convolutional neural network (MCNN) sharing the lowest layers amongst all attributes, sharing the higher layers for related attributes, and by building an auxiliary network on top of the MCNN which utilizes the scores from all attributes to improve the final classification of each attribute.

Attributes are mid-level representations that can be used for the recognition of activities, objects, and people. Attributes can provide an abstraction between the low-level features and the high-level labels. Attributes can be used in face recognition and verification. In the face recognition domain, attributes can include gender, race, age, hair color, facial hair, and so on. These semantic features can be very intuitive, and can allow for much more understandable descriptions of objects, people, and activities.

Reliable estimation of facial attributes can be useful for many different tasks. Human computer interaction (HCl) applications may require information about gender in order to properly greet a user, such as Mr. or Ms., and other attributes such as expression in order to determine the mood of the user. Facial attributes can be used for identity verification in low quality imagery, where other verification methods may fail. Suspects are often described in terms of attributes, and so they can be used to automatically search for suspects in surveillance video. Attributes can be used to search a database of images very quickly. They can be used in both image search and retrieval

Convolutional neural networks (CNNs) have replaced most traditional methods for feature extraction in many computer vision problems. They can be effective in attribute classification as well. However, as mentioned above, attributes have generally been treated as independent from each other. From a simple example, a woman wearing lipstick and earrings, it can be seen that the attributes are not highly independent. If a subject is wearing lipstick and earrings, the probability that the subject is a woman is much higher than if they did not exhibit those attributes, and the reverse is also true. Treating each attribute as independent may fail to use the valuable information provided by the other attributes. Attributes can fit nicely into a multi-task learning framework, where multiple problems can be solved jointly using shared information.

In certain embodiments, therefore, a multi-task deep CNN (MCNN) with an auxiliary network (MCNN-AUX) on top can be applied in order to utilize information provided by all attributes in three ways: by sharing the lower layers of the MCNN for all attributes, by sharing the higher layers for similar attributes, and by utilizing all attribute scores from the MCNN in an auxiliary network in order to improve the recognition of individual attributes.

Multi-task learning (MTL) can be a way of solving several problems at the same time utilizing shared information. MTL has found success in the domains of facial landmark localization, pose estimation, action recognition, face detection, as well as other areas.

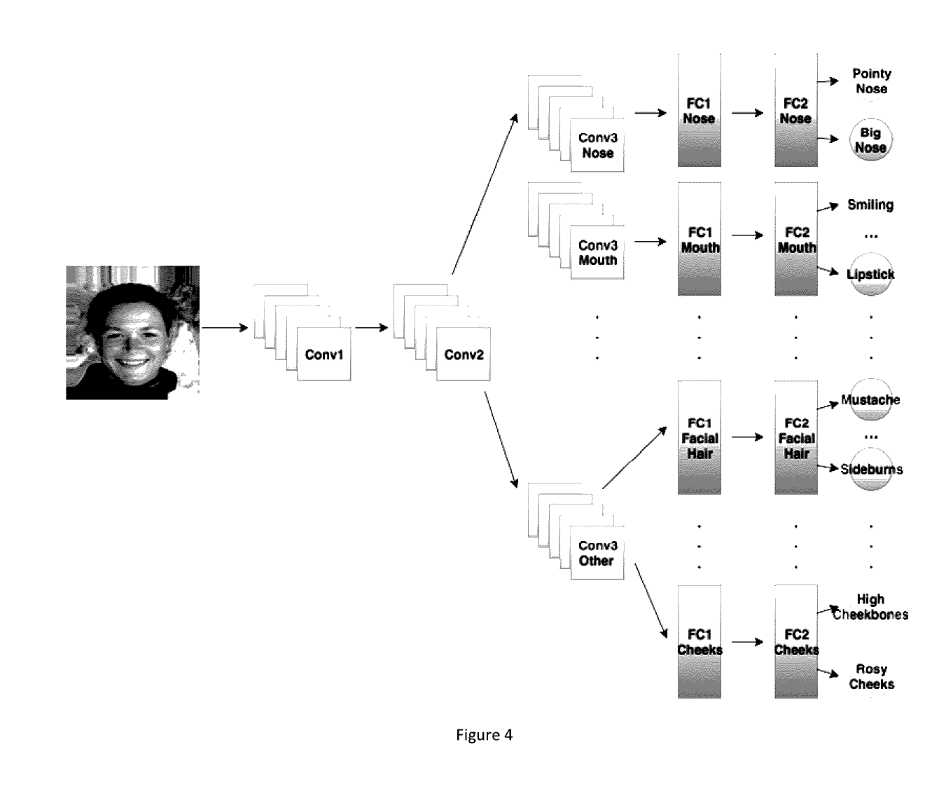

FIG. 4 illustrates a multi-task convolutional neural network according to certain embodiments. Conv1 can include 75 7×7 convolution filters, and can be followed by a ReLU, 3×3 Max Pooling, and 5×5 Normalization. Conv2 can have 200 5×5 filters and can also be followed by a ReLU, 3×3 Max Pooling, and 5×5 Normalization. Conv1 and Conv2 can be shared for all attributes. After Conv2, groupings can be used to separate the layers. There can be nine groups in all: Gender, Nose, Mouth, Eyes, Face, AroundHead, FacialHair, Cheeks, and Fat. There are can be 6 Conv3s: one each for Gender, Nose, Mouth, Eyes, and Face, and one for the remaining groups—Conv3Rest. Each Conv3 can have 300 3×3 filters and can be followed by a ReLU, 5×5 Max Pooling and 5×5 Normalization. The Conv3s can be followed by fully connected layers, FC1. There can be 9 FC is—one for each group. Each FC1 can be fully connected to the corresponding previous layer, with Conv3Rest connected to the FC is for AroundHead, FacialHair, Cheeks, and Fat. Every FC1 can have 512 units and can be followed by a ReLU and a 50% dropout to avoid over fitting. Each FC1 can be fully connected to a corresponding FC2, also with 512 units. The FC2s can be followed by a ReLU and a 50% dropout. Each FC2 can then be fully connected to an output node for the attributes in that group. The attributes for each group, in one example, are as follows: for gender, male; for nose, big nose and pointy nose; for mouth, big lips, smiling, lipstick, and mouth slightly open; for eyes, arched eyebrows, bags under eyes, bushy eyebrows, narrow eyes, and eyeglasses, for face attractive, blurry, oval face, pale skin, young, and heavy makeup; for AroundHead, black hair, blond hair, brown hair, gray hair, earrings, necklace, necktie, receding hairline, bangs, hat, straight hair, and wavy hair; for FacialHair, 5 o'clock shadow, mustache, no beard, sideburns, and goatee; for cheeks, high cheekbones and rosy cheeks; and for fat, chubby and double chin.

The groups can be chosen, as in this example, according to attribute location. Some groupings can be separated from others and some can be absorbed into others depending on the desired results. For example, if male is kept separate from all other attributes the gender results may not be as good as with sharing, but the performance of the other attributes may be improved. A compromise may be, for example, to include male in the shared Conv1 and Conv2 layers and then to have separate Conv3, FC1, and FC2 layers.

If an independent CNN were used for each attribute following the architecture of one path in the MCNN, 3 convolutional layers and 3 fully connected layers, each CNN would have over 1.6 million parameters. So, for all 40 attributes, there would be over 64 million parameters. Using MCNN, this can be reduced to less than 15 million parameters, over four times fewer.

After training the MCNN, a fully connected layer, AUX, can be connected after the output of the trained MCNN. Starting with the weights from the trained MCNN, the weights for the AUX portion of the network can be learned, keeping the weights from the MCNN constant. The AUX layer can allow for interactions amongst attributes at the score level. The MCNN-AUX network can learn the relationship amongst attribute scores in order to improve overall classification accuracy for each attribute.

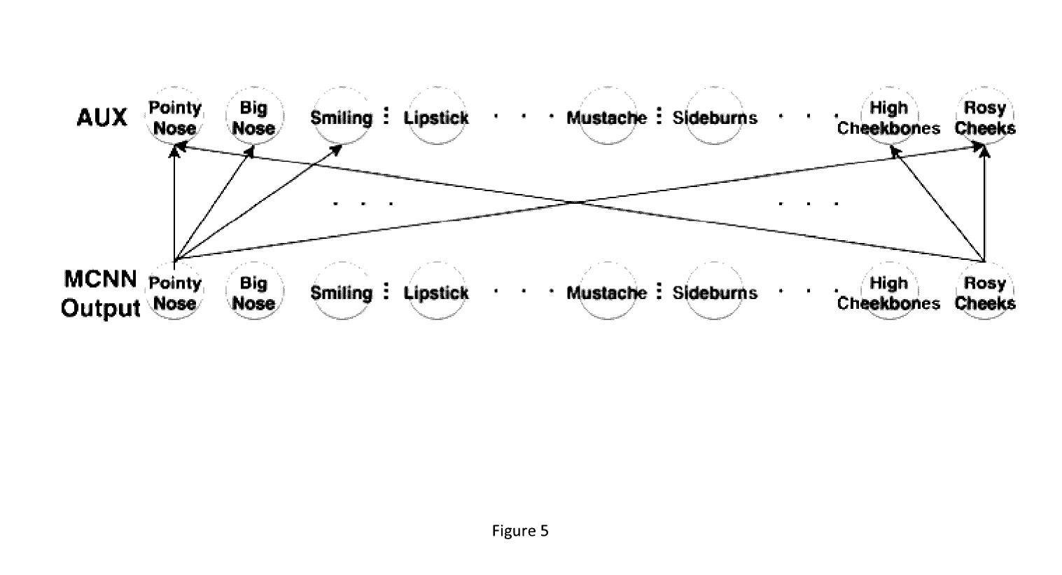

FIG. 5 shows the connection between MCNN and AUX, according to certain embodiments. The AUX layer may only add 1600 parameters to the 1.6 million from MCNN. The output of the MCNN can be fully connected to the AUX layer, allowing for learning of relationships amongst attributes at the score level. This combination of networks is one example of systems and methods that can be used for obtaining attributes of a user of a mobile device.

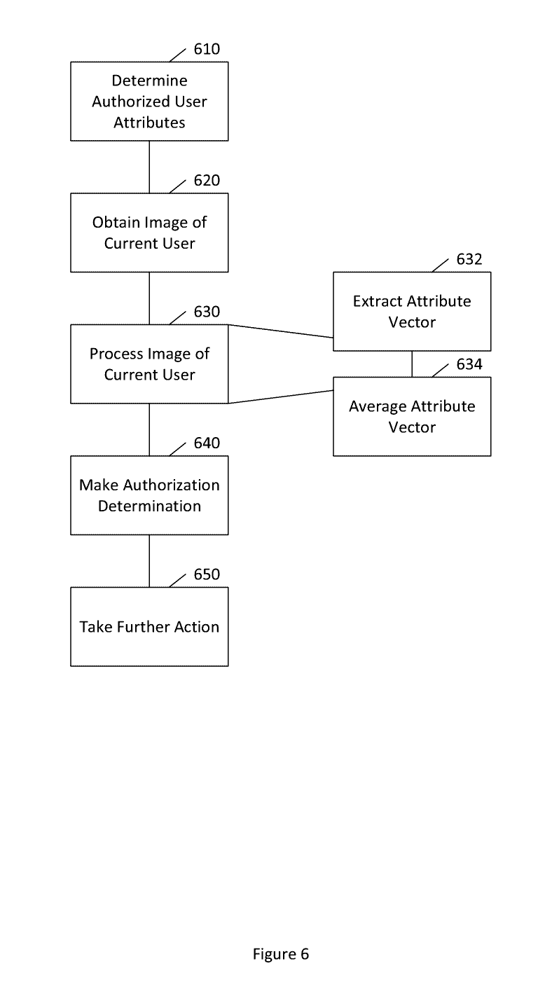

FIG. 6 illustrates a method according to certain embodiments. As shown in FIG. 6, a method can include, at 610, determining attributes of an authorized user of a mobile device. The attributes can be determined in a variety of ways, such as by text input by the authorized user, from a profile of the user, or from an image or video of the user. In certain embodiments, the process of determining these attributes can be referred as enrollment of the attributes. The enrollment process can take place a single time, periodically, or triggered by some event, such as unlocking the mobile device. Other methods of enrollment, such as sharing attributes obtained at another device, are also permitted.

The method can also include, at 620, obtaining an unconstrained image of a current user of the mobile device. This unconstrained still or video image can be obtained automatically, for example, using a camera of the mobile device that points toward the user of the device. The obtained image can be obtained periodically or when triggered by an event such as opening a new application or an application with a particular security setting or classification. For example, accessing an application that has access to personal data of the user may trigger obtaining the image, even if the user had previously and recently authenticated.

The method can further include, at 630, processing the unconstrained image to determine at least one characteristic of the current user. The at least one characteristic can include a plurality of characteristics, and the authorization determination can be based on a correlation between or among the plurality of characteristics, as described above, for example, with reference to FIGS. 4 and 5. The processing can include a part-based attribute detection, where, for example, various partial features of a face are taken into account, as described above. Thus, the at least one characteristic can be or include an attribute extracted from a face of the current user.

In the case where the image is a video image, the method can further include, at 632, extracting an attribute vector from each image in the video. The method can also include, at 634, averaging the attribute vectors to obtain a single attribute vector representative of the video. In the case of a still image, an attribute vector can be similarly obtained and can simply be used without averaging.

The method can additionally include, at 640, making an authorization determination based on a comparison between the attributes and the determined characteristic. The authorization determination can include determining whether a level of confidence exceeds a threshold. The authorization determination is made without determining the identity of the current user. For example, in certain cases confirming that the gender of the current user, the chubbiness of the current user, and the eyeglasses condition of the current user matches the authorized user may be enough to indicate that the current user is authorized, even though such details do not uniquely identify the user.

The method can also include, at 650, taking some further action based on the authorization determination, such as locking the device, logging the apparent lack of authorization, and/or reporting the apparent lack of authorization. The obtained image can be stored or forwarded. In certain cases, the image can be used to update the enrolled attributes of the current user.

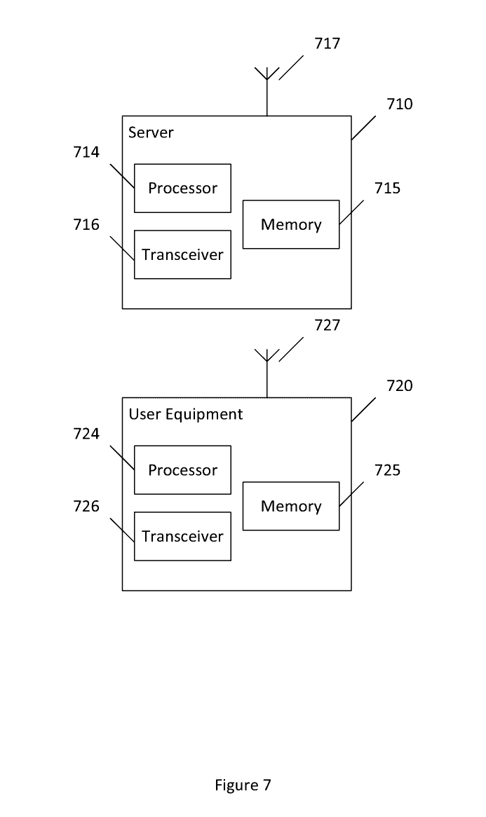

FIG. 7 illustrates a system according to certain embodiments of the invention. It should be understood that each block of the flowchart of FIG. 6 may be implemented by various means or their combinations, such as hardware, software, firmware, one or more processors and/or circuitry. In one embodiment, a system may include several devices, such as, for example, server 710 and user equipment (UE) or user device 720. The system may include more than one UE 720 and more than one server 710, although only one of each is shown for the purposes of illustration. A server can be a computing system or collection of computing systems.

Each of these devices may include at least one processor or control unit or module, respectively indicated as 714 and 724. At least one memory may be provided in each device, and indicated as 715 and 725, respectively. The memory may include computer program instructions or computer code contained therein, for example for carrying out the embodiments described above. One or more transceiver 716 and 726 may be provided, and each device may also include an antenna, respectively illustrated as 717 and 727. Other configurations of these devices, for example, may be provided. For example, server 710 and UE 720 may be additionally configured for wired communication, in addition to wireless communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. One or more functionalities may also be implemented as a virtual application that is provided as software that can run on a server.

A user device or user equipment 720 may be a mobile station (MS) such as a mobile phone or smart phone or multimedia device, a vehicle, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof.

In an exemplifying embodiment, an apparatus, such as a node or user device, may include means for carrying out embodiments described above in relation to FIG. 6.

Processors 714 and 724 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or units of at least one chip set (e.g., procedures, functions, and so on). Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as server 710 and/or UE 720, to perform any of the processes described above (see, for example, FIG. 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 7 illustrates a system including a server 710 and a UE 720, embodiments of the invention may be applicable to other configurations, and configurations involving additional elements, as illustrated and discussed herein. For example, multiple user equipment devices and multiple servers may be present.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
determining attributes of an authorized user of a mobile device;
obtaining an unconstrained image of a current user of the mobile device;
processing the unconstrained image to determine at least one characteristic of the current user; and
making an authorization determination based on a comparison between the attributes and the determined characteristic.

2. The method of claim 1, wherein the attributes are determined from text input by the authorized user.

3. The method of claim 1, wherein the authorization determination comprises determining whether a level of confidence exceeds a threshold.

4. The method of claim 1, wherein the at least one characteristic comprises a plurality of characteristics, wherein the authorization determination is based on a correlation between or among the plurality of characteristics.

5. The method of claim 1, wherein the attributes are determined from at least one image of the authorized user.

6. The method of claim 1, wherein the at least one characteristic comprises an attribute extracted from a face of the current user.

7. The method of claim 1, wherein the authorization determination is made without determining the identity of the current user.

8. The method of claim 1, wherein the processing comprises a part-based attribute detection.

9. The method of claim 1, wherein obtaining an unconstrained image comprises obtaining a video.

10. The method of claim 9, further comprising:
extracting an attribute vector from each image in the video; and
averaging the attribute vectors to obtain a single attribute vector representative of the video.

11. An apparatus, comprising:
at least one processor; and
at least one memory including computer program code,
wherein the at least one memory and the computer program code are configured to, with the at least one processor, cause the apparatus at least to
determine attributes of an authorized user of a mobile device;
obtain an unconstrained image of a current user of the mobile device;
process the unconstrained image to determine at least one characteristic of the current user; and
make an authorization determination based on a comparison between the attributes and the determined characteristic.

12. The apparatus of claim 11, wherein the attributes are determined from text input by the authorized user.

13. The apparatus of claim 11, wherein the authorization determination comprises determining whether a level of confidence exceeds a threshold.

14. The apparatus of claim 11, wherein the at least one characteristic comprises a plurality of characteristics, wherein the authorization determination is based on a correlation between or among the plurality of characteristics.

15. The apparatus of claim 11, wherein the attributes are determined from at least one image of the authorized user.

16. The apparatus of claim 11, wherein the at least one characteristic comprises an attribute extracted from a face of the current user.

17. The apparatus of claim 11, wherein the authorization determination is made without determining the identity of the current user.

18. The apparatus of claim 11, wherein the processing comprises a part-based attribute detection.

19. The apparatus of claim 11, wherein obtaining an unconstrained image comprises obtaining a video.

20. The apparatus of claim 19, wherein the at least one memory and the computer program code are configured to, with the at least one processor, cause the apparatus at least to
extract an attribute vector from each image in the video; and
average the attribute vectors to obtain a single attribute vector representative of the video.
